(19) United States
(12) Patent Application Publication
(10) Pub. No.: US 2004/0143977 A1
(43) Pub. Date: Jul. 29, 2004

(54) SINGLE-USE DISPOSABLE SHAVING SET

(76) Inventor: Ali Saban Selek, ISTANBUL (TR)

Correspondence Address: SABAN ALI SELEK, BA6DAT CAD. 217-A-10, IDEALTEPE, ISTANBUL, 80380, TR

(21) Appl. No.: 10/248,510

(22) Filed: Jan. 24, 2003

(51) Int. Cl. B26B 21/00

(52) U.S. Cl. 30/526

(57) ABSTRACT

A single-use disposable shaving set composed of three pieces; first piece being a shaving foam cartridge containing pressurized shaving foam sufficient for a single shave, second piece being an aftershave liquid cartridge containing a kind of after shave liquid sufficient for a single shave, and the third piece being a blade assembly having at least a blade coupled thereto; all three said pieces contained in a wrapped box slightly bigger than a standard matchbox without being mounted in order to occupy the smallest space possible, under a hygienic condition; the foam cartridge and the aftershave liquid cartridge forming the handle of a shaving machine when mounted together and all forming a shaving machine when the blade assembly is mounted to the said handle; the set featuring all the minimum requirements of a well wet shave; the entire set to be disposed off after a single use.

### BACKGROUND OF INVENTION

One of the most significant problems encountered by traveling men is carrying the shaving set. Particularly in voyages confined to overnight, finding a suitable place for the shaving set poses a real dilemma.

Although most of the hotels equip their rooms with soap, shampoo and, at times tooth-paste and brush, hair-combs and even perfume, hardly any hotel managements ponder to provide shaving sets. One of the foremost pretexts for their failure is probably the cost-factor since a shaving-machine alone appears of no functional use, requiring the addition of shaving cream and/or foam and shaving-lotion as accompaniments.

Presumably stimulated by such necessities, inventors have devised and formulated various solutions to the predicament, up today. Known prior art disposable razors invented particularly to meet the needs of travelers include U.S. Pat. No. 4,129,942 of Denizman; U.S. Pat. Nos. 4,791,723 and 4,908,945 of Jacobson; U.S. Pat. No. 5,855,066 of Menger and WO Pat. No. 97/18065 of Kim.

In the same context, although primarily aimed at facilitating usage by the travelers, our invention is fraught with unique characteristics, distinctly different from its comparables. In a way that:

a) The invention is composed of three basic parts and at the preliminary phase, these parts are placed in a box, in a de-mounted format; turning into a shaving-machine when mounted.

b) The invention is structured to contain both shaving foam and after-shave liquid, the major prerequisites of a well wet shave.

c) The box that contains the three parts is an integral and complementary piece of the invention itself, just like the containers of the audiocassettes and CDs.

d) The dimensions of the box are slightly larger than a standard matchbox. In that regard, it occupies considerably less spaces and can be conveniently carried along to any place. In fact, the underlying reason for presenting the shaving-machine's components in a demounted form and inserting them into a box is that the invention is intended to take less space and transported with comfort and ease. The sizes of each item are designed and adjusted so that the box's aggregates are maintained intact and at a minimum dimension.

e) The box is wrapped by gelatin and/or a corresponding substance; owing to this determinant, all of the parts inside are to be construed as extremely hygienic.

f) The invention is solely for single use. This aspect also reinforces its hygienic supremacy.

In contrast, the other inventions:

a) May be utilized more than once.

b) They resemble the disposable shaving-machines whose start-up positions are known.

c) The basic goal in their development is not that the invention should occupy scant space as a disposable razor, but feature multi functions.

d) They are devoid of any hygienic concerns and considerations.

e) A majority of the products is unable to accommodate after-shave fluid.

### SUMMARY OF INVENTION

The expansion of transportation means and a reduction in travel costs has brought on the agenda the possibility of making business trips with a shorter duration. In general, preferring air voyage for this type of trips, the people tend to carry cabin-friendly small luggage and bags in order to ward off the frustration of waiting out their baggage at the terminals. By inference, due to the fact that the internal spaces of the underlined bags are limited, the choice of items will have to be selective, restricted at the minimum measurements, while aspiring for an optimum benefit from diversified items. Furthermore, the menace of terror has also imposed significant restraints on the belongings that could be potentially allowed on board the aircraft cabins.

When a randomly selected ordinary disposable shaving-machine, currently available on the market, is placed on a plain surface horizontally, the highest point that could be measured in perpendicular to the plane may not submerge below 25 mm. This height is also reflected on the packaging of the shaving-machines: consequently, the thickness of the thinnest packet of a shaving-machine set ranges above 25 mm.

In a similar manner, the lengths of the shaving-machines, spanning the extent from the edge of their stems up to their tips, varies between 12-15 cm. Taking into account the fact that the width of their shaving heads is concentrated around 4-5 cm, it will be evident that, on business trips undertaken with a small bag, finding a place for the shaving-machine and the accompanying shaving foam and the after-shave, occupying an equally expansive space, will be truly challenging. Thus, the invention measures a maximum thickness of 12 mm, a width of 45 mm and a length of 75 mm, occupying merely 25% of the volume accounted for only by the cover-package of the shaving-machine, among the articles enumerated above; in conclusion, it offers a unique alternative, designed to satisfy the mentioned need in an optimum manner.

On the other hand, the demand for hygienic and single-use products has undergone a noticeable escalation recently, originating from the developed societies and subsequently—spreading to the entire globe. To cite a few examples: vaccination syringes, diapers, menstrual pads, potable water in PET-containers and soft drinks in disposable and non-refundable bottles and cans. It is possible to list several more other examples. The reasons that have created this incessant demand may be attributed to a plethora of factors. However, as their common denominators and foremost constituents, we may specify the following slug-lines:

The incomes of the nations and invariably the wealth of the individuals are steadily increasing.

People with enhanced income are comparably more conscious allocating some of their assets to health and, in particular, to safeguarding health.

As the public demand intensifies for such personal-care products, the R&D activities in a wide field in the health sector also expand, gradually paving the way for a further sophistication and development in the product-spectrum, focusing specifically on augmented practical use and simplified features. Conceivably, the heightened competition drives their prices down, in due course, enabling a wider segment of the society to employ them regularly.

Specifically, in the case of the shaving materials, as a natural instinct of protection against diverse skin diseases, led particularly by AIDS, the dissemination of disposable products has gained a remarkable momentum recently. Especially the progress from conventional razor to disposable razor blades has to be remarked. However, the current point is not satisfactory. Although they may be explicitly designated as such, there is a widespread tendency to use razor blades more than once. This probability lends credence to the following possibilities, replete with the obvious risks:

For example, is there any guarantee that a razor blade abandoned in a hotel room will not be picked and used by a member of the hotel's cleaning staff?

Who could be entirely certain that a guest at our house has not used the shaving-equipment in our bathroom?

Is it a far-fetched concern that the cleaner, summoned to our home, has trimmed his/her armpits with the razor blade that has been left there, in the open?

Would it not be possible for our children (could be also the guests” children) to try our shaving gadgets just out of curiosity?

Similar questions, as exemplified above, will multiply in due time and, without doubt, will contribute to the increase in the general public's demand for single-use disposable shaving items in an accelerating pace.

When evaluated within the context of the above-specified two main constraints, it becomes perfectly clear that there is a necessity for a product at least meeting the needs specified therein. Therefore, while designing the invention, it is aimed that the invention should at least meet the criteria listed below:

1. It should occupy as small place as possible.

2. It should be easy-to-use and practical.

3. It should conform to hygienic requirements and standards.

4. It should incorporate an after-shave product, in conjunction also with a pressurized shaving-foam and/or cream. In this manner, it should stand out as a complete set such that the user should feel no demand for any other material.

5. It should be for a single-use.

6. Its manufacturing should be simple and economical.

7. As a product that shall be used with confidence and full safety in the hotels and on board the aircraft, it should be provided both with a price and/or gratis.

8. Guests who arrive without the adequate provisions in their possession should not be coerced to use their host's shaving implements.

9. The products should be sold also on the outside vending machines.

Finally, the invention targets to alleviate this prerequisite both in the most practical and exceptionally hygienic way, in a short-term perspective, while, in a medium- and long-term approach, contemplating also to attract virtually all consumers who uphold the tenets of hygiene.

### BRIEF DESCRIPTION OF DRAWINGS

The invention will be better understood and objects other than those set forth above will become apparent when consideration is given to the following detailed description thereof. Such description makes reference to the annexed drawings wherein:

FIG. 1 is a perspective view of the present invention in its initial demounted form.

FIG. 2 is a front view of the present invention in mounted form.

FIG. 3 is a side view of the present invention in mounted form.

FIG. 4 is a section view of the shaving foam cartridge portion of the present invention.

FIG. 5 is a section view of the two sub-parts of the shaving foam cartridge in FIG. 4, illustrated for having a clear view, eliminating overlapping.

FIG. 6 is a fragmentary perspective view of the aftershave liquid cartridge portion of the present invention.

FIG. 7 is a fragmentary top view of the blade assembly portion of the present invention.

FIG. 8 illustrates how the shaving foam cartridge is mounted on the aftershave liquid cartridge to form a handle.

FIG. 9 illustrates how the handle looks like when mounted in FIG. 8.

FIG. 10 is a partial section view of the shaving foam cartridge of the present invention showing details of its position before dispensing the shaving foam therein.

FIG. 11 is a partial section view of the shaving foam cartridge of the present invention showing details of its position after pressing the multifunctional cap in order to dispense the shaving foam.

FIG. 12 illustrates how the blade assembly is mounted on the handle to form a shaving machine.

FIG. 13 illustrates the first alternative of facilitating the after-shave liquid contained in the aftershave liquid cartridge of the present invention.

FIG. 14 illustrates the second alternative of facilitating the after-shave liquid contained in the aftershave liquid cartridge of the present invention.

### DETAILED DESCRIPTION

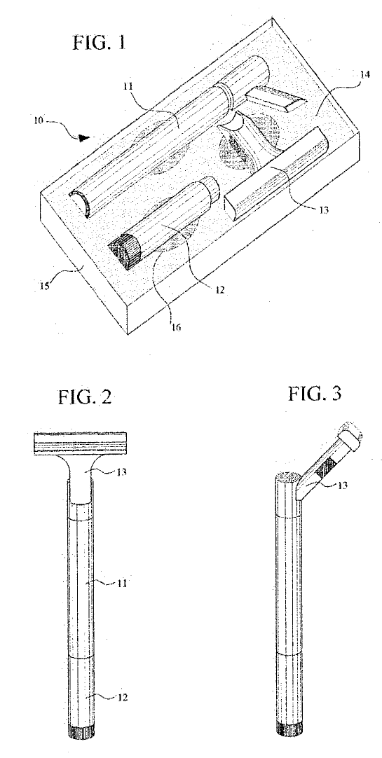

In the illustrative embodiments of the invention as shown in FIG. 1, a single-use disposable shaving set generally designated the numeral 10 will be described. The present invention includes a shaving foam cartridge 11, an aftershave liquid cartridge 12 and a blade assembly 13, converting into a shaving machine when inserted into each other; all three placed on a fixing bed 14 which is contained in an open-top box 15. FIGS. 2 and 3 show how they shall look like when mounted.

The fixing-bed 14, preferably made of sponge has grooves 16 at both sides of each part for easy pick-up. Each part should tightly be placed such that, before the box is opened, it should not make any noise when shaken.

Since the invention is designed especially for traveling businessman, dimensions of each part are very important. Main idea is that the set should be easily portable, even in a man's matchbox pocket. With such an understanding, when placed horizontally, ideally the height of no part should exceed 12 mm so that the height of the box should not exceed 14 mm. Similarly, when the three parts are placed in the box as shown in FIG. 1, the width of the box should not exceed 50 mm and the length 80 mm. The box, weather designed like a matchbox having a drawer or an open top, should be wrapped with cellophane in order to maintain a hygienic environment inside, required to begin at the production process.

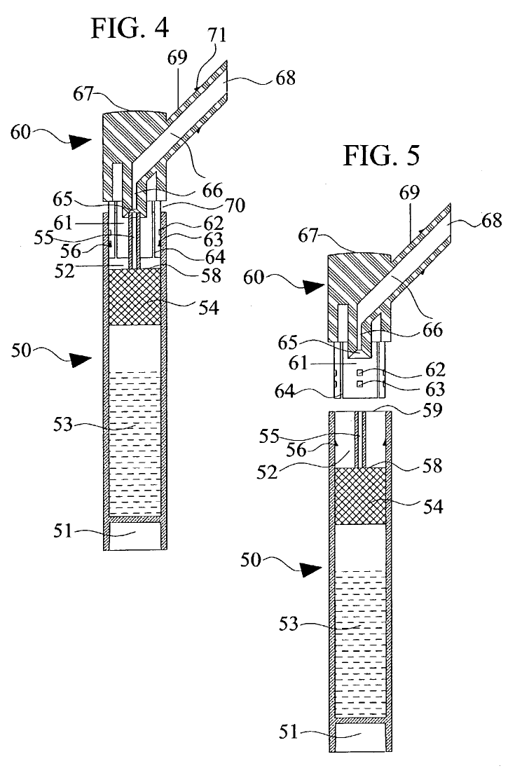

The details of each part are illustrated through FIGS. 4 to 7. The cylindrical pressurized chamber 50 of the shaving foam cartridge in FIG. 4 has a cylindrical socket 51 at the bottom, wide and deep enough to exactly fit the closed-top fitting-socket 81 of the aftershave liquid cartridge 12 and a cylindrical socket 52 at the top, wide and deep enough to fit the open-top fitting-socket 61 of the multifunctional cap 60. The details of the shaving foam cartridge may be better understood when they are illustrated in disassembled form as in FIG. 5. There is pressurized foam 53 in the chamber 50 and it is sealed with an aerosol valve 54. There are four triangular elastic catches 56 located horizontally at the same level having equal distance to each other on the inner walls of the socket 52. There are two levels of rectangular holes with a total of eight located horizontally 62, 63 and four vertical openings 64 on the walls of the open-top fitting-socket 61 of the multifunctional cap 60; the openings 64 dividing said walls into four elastic leaves which enable each leaf easily bend inwards when they pass over the triangular catches 56 while moving downwards. The multifunctional cap 60 and the pressurized chamber 50 are assembled at the factory such that the catches 56 and the bottom level holes 63 meet and hold each other, whereas the funnel-shaped mouth 65 of the passageway 66 just touching and closing the tip of the nozzle 55 of the aerosol valve 54. The catches 56 are used to eliminate removal of the multifunctional cap 60 at the first position. At this position, there exists a distance 70 to go between the multifunctional cap 60 and pressurized chamber 50 which is used to activate the aerosol valve. For this purpose, the multifunctional cap 60 is firmly pressed downwards by pressing on the circular surface 67 which causes the multifunctional cap go down such that the catches 56 leave the lower level holes 63 and catch the upper level holes 62 at the level where the distance 70 is fully closed. At this position, the multifunctional cap 60 and the pressurized chamber 50 are tightly mounted to each other. While pressing, force is applied also on the nozzle 55 of the aerosol valve 54 by the funnel-shape mouth 65 of the passageway 66 at the center of the multifunctional cap, causing said nozzle 55 go downwards and the aerosol valve 54 open and remain in the open position, thus avoiding the necessity of applying continuous force on circular surface 67. When the aerosol valve is opened, the pressurized foam flows through the valve nozzle first and flowing through the passageway 66, finally expels from the mouth 68 of the nozzle 69 of the multifunctional cap. The nozzle 69 of the multifunctional cap 60 has a semi-circular section, wide and long enough to exactly fit into the hollow 93 of the blade assembly 13 and there are catches 71 on its outer surface for a tight mounting with the blade assembly 13.

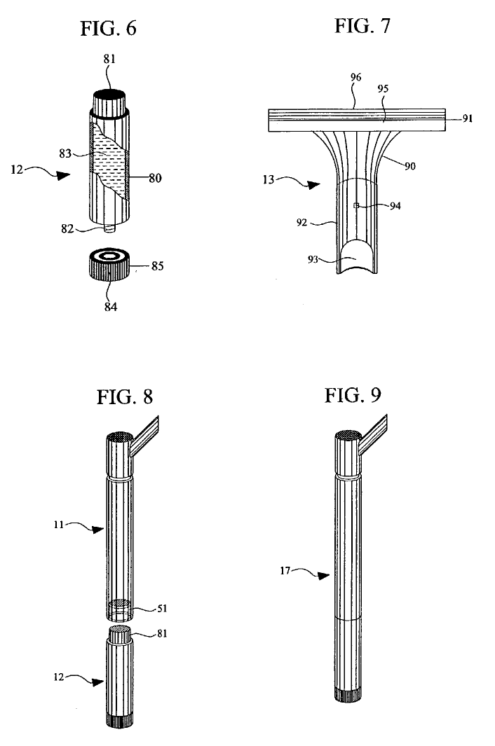

The aftershave liquid cartridge in FIG. 6 has a cylindrical body 80 being the same diameter with that of the shaving foam cartridge, equipped with a cylindrical fitting-socket 81 at the top thick and long enough to exactly fit into the socket 51 of shaving foam cartridge and a cylindrical discharge nozzle 82 at the bottom, defining an interior space 83 with an adequate volume to contain enough after-shave liquid for a single use. There are grooves 84 perpendicularly placed all over the outer surface of the lid 85 for easy remove. The lid is of the same diameter with that of the body and suitable for tightly sealing the liquid contained therein.

The blade assembly in FIG. 7 has a triangular body 90 having a rectangular conventional shaving head 91 at one edge with at least one blade coupled thereto. There are grooves 92 along the other two edges to seize and facilitate the mounting operation. The interior part of the blade assembly is a hollow 93 in the form of a semi-circle with holes 94 on the walls to fit to the catches on the outer surface of the nozzle of the multifunctional cap of shaving foam cartridge, such that the semi-circular form assures a right mounting with a unique angle whereas the catches are used for a tight and non-removable mount. The blade/blades 95 are protected by a soft nylon film 96 fastened at the edges of shaving head, which can be easily peeled off, with an additional function of preventing injuries.

In FIGS. 8 to 14, a step-by-step illustration is provided on how and in which order the said three parts are mounted to form a shaving machine.

Firstly, the aftershave cartridge 12 is mounted on the shaving foam cartridge 11 such that the fitting-socket 81 of the aftershave cartridge is inserted tightly into the bottom socket 51 of the shaving foam cartridge as shown in FIG. 8. When mounted, the two parts constitute the handle 1 7 of the shaving machine as illustrated in FIG. 9.

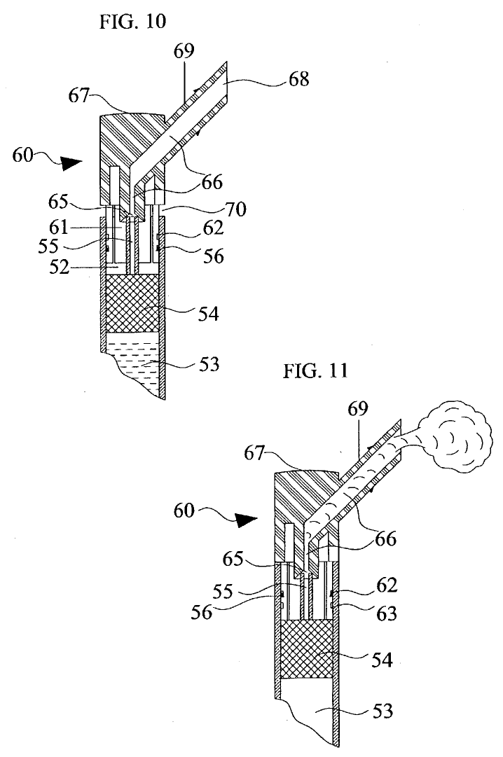

At this stage, as illustrated in FIGS. 10 and 11, the circular surface 67 of the multifunctional cap 60 at the top of the handle is pressed as far as it goes until a click sound is heard where the catches 56 on the walls of the socket 52 are inter-locked with the upper level rectangular holes 62 placed horizontally on the surface of the open-top fitting-socket 61 irretrievably and holding each other firmly. While pressing, force is applied also on the nozzle 55 of the aerosol valve 54 by the funnel-shape mouth 65 of the passageway 66 at the center of the fitting-socket, causing said nozzle 55 go downwards and the aerosol valve 54 open and remain in open position, thus avoiding the necessity to apply continuous force on circular surface 67. Once the aerosol valve 54 is open, the pressurized foam contained in the chamber 53 flows first through the nozzle 55 of the aerosol valve, reaching the passageway 66 of the multifunctional cap 60, finally pouring out of the mouth 68 of the nozzle 69 of the multifunctional cap.

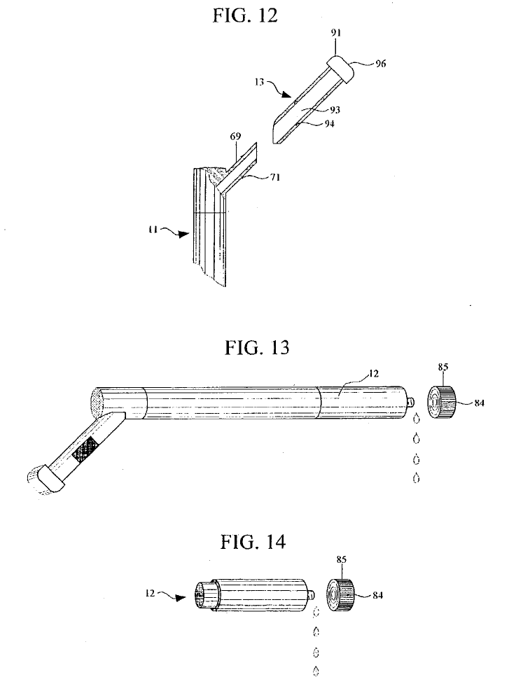

FIG. 12 illustrates how to mount the blade assembly 13 on the handle after the foam is dispensed. At this point, it is expected that the foam is applied to the face. Then, the blade assembly has to be mounted to the handle as shown. Because of the semi-circular form of the nozzle 69 of the multifunctional cap 60 and of the hollow 93 inside the blade assembly, the blade assembly can be mounted to the handle only with a unique angle. The catches 71 located on the outer surface of the nozzle 69 of the multifunctional cap and the holes 94 located on the inner surface of the hollow assure a right and tight mounting whereas preventing their loosening while shaving. Once the blade assembly is tightly secured to the handle, the blade protector 96 stuck on the shaving head 91 is peeled off.

Composed of three main parts, FIG. 2 and 3 shows the shaving machine's general appearance from front and side view after the mounting process is over. Now it can be used for shaving. Following the shaving, the aftershave liquid contained in the aftershave liquid cartridge 12 is poured out by opening the lid 85 that seals it. There may be vertical grooves on the outer surface 84 of the lid 85 enabling an easy turn. For pouring out the aftershave liquid, the aftershave liquid cartridge can be removed from the shaving machine before opening the lid 85 or it may be done without removal as illustrated in FIGS. 13 and 14.

This step finishes the process of mounting and also shaving. In the last step, the used shaving machine is disposed of properly making sure that nobody can use it in view of the risk of an infection.

The preferred embodiment of the invention described above has not to be understood as constrained to the details of illustrations and explanations therein. Also, it is to be understood that the phraseology and terminology employed herein are for the purpose of description and should not be regarded as limiting.

I claim;

1. A single-use disposable shaving set composed of three pieces; first piece being a shaving foam cartridge containing pressurized shaving foam sufficient for a single shave, second piece being an aftershave liquid cartridge containing a kind of after shave liquid sufficient for a single shave, and the third piece being a blade assembly having at least a blade coupled thereto; the foam cartridge and the aftershave liquid cartridge forming the handle of a shaving machine when mounted together and all forming a shaving machine when the blade assembly is mounted on the said handle; all three said pieces contained in a wrapped box slightly bigger than a standard matchbox without being mounted in order to occupy the smallest space possible; the entire set to be disposed off after a single use.

2. A single-use disposable shaving set comprising;
An aftershave liquid cartridge having a cylindrical body made of hard plastic; said cartridge having a cylindrical discharge nozzle at one end and a cylindrical fitting-socket at the other end, defining an interior space containing a kind of after shave liquid enough for single use; said cylindrical discharge nozzle having a diameter less than half of that of the said body and having an interior hole through which the aftershave liquid can easily flow out with a soft shake; said cylindrical fitting-socket having a diameter less than that of the body, being long and thick enough to enable a tight mounting to the bottom socket of the shaving foam cartridge; said aftershave liquid cartridge also having a cylindrical lid of the same diameter of the body, used to close and seal said cylindrical discharge nozzle;
A blade assembly made of hard plastic in triangular form; at one edge of said blade assembly, a rectangular conventional shaving head is located; said shaving head having at least one blade coupled thereto; said blade/blades being protected by a soft nylon film fastened to the edges of the shaving head; beginning from the edge on which the shaving head is fixed going to the opposite edge, the blade assembly getting narrower forming a triangular body whilst defining a semi-circular hollow inside long and wide enough to fit and cover the discharge nozzle of multifunctional cap of the shaving foam cartridge; on the walls of the hollow, holes exist to fit to the catches on the surface of the discharge nozzle of said multifunctional cap, to enable a tight mounting whereas also preventing dismount;
A shaving foam cartridge composed of a pressurized chamber and a multifunctional cap made of hard plastic, which have to be assembled together at the production process:
The pressurized chamber being in the form of a cylindrical tube having a cylindrical socket at the bottom, deep and wide enough to exactly fit the fitting-socket of the aftershave liquid cartridge and a cylindrical socket at the top end, deep and wide enough to roughly fit the fitting-socket of the multifunctional cap, defining an interior space containing pressurized shaving foam; over said interior space, forming also the bottom of the socket on the top end, an aerosol valve is located as deep from the open top of the socket as the length of the nozzle of said aerosol valve, sealing said pressurized shaving foam contained therein; the socket at the top having triangular catches on the inner walls located horizontally at the same level with each other being used to avoid the multifunctional cap to disassemble; said catches being also used to lock the aerosol valve in open position once pressed;
The multifunctional cap being in the form of a cylinder with the same diameter that of the pressurized chamber, having an open-top cylindrical fitting-socket at the bottom, long and wide enough to roughly fit the upper socket of the pressurized chamber; around said fitting-socket two levels of holes are located horizontal to the body which fit the catches on the inner walls of the upper socket of the pressurized chamber; beginning from a small distance below of the upper edge of the multifunctional cap, a discharge nozzle coming out and going upwards making a 135° angle with the cylindrical body of the multifunctional cap; said discharge nozzle having a semi-circular form, thick and long enough to fit to the semi-circle shaped hollow of the blade assembly and having catches on the outer walls to fit the holes on the walls of the hollow of the blade assembly to enable a tight mounting with the blade assembly whereas also avoiding removal; the top of the cylindrical body being in the form of a notched circular surface suitable for pressing downwards with the thumb or the forefinger; throughout said multifunctional cap locating a passageway beginning from the center of the bottom side at the level where the fitting-socket finishes and the cylindrical body begins, said passageway going all the way through the body and the discharge nozzle but wider inside the discharge nozzle such that at the end of the discharge nozzle forming a discharge mouth throughout which the shaving foam can be easily dispensed; the beginning point of said passageway getting wider downwards forming a mouth like a funnel, wide and deep enough to cover and close the top of nozzle of the aerosol valve such that the pressurized foam coming through the nozzle of the aerosol valve can easily pass into the passageway once the aerosol valve is open;
The pressurized chamber and the multifunctional cap to be assembled at factory, creating a shaving foam cartridge such that: the fitting-socket of the multifunctional cap is inserted into the upper socket of the pressurized chamber up to the level where the lower holes located on the outer surface of said fitting-socket are inter-locked with the catches located on the walls of the upper socket of pressurized chamber, leaving a space for the fitting-socket to go further as long as the distance between the two levels of the holes, placed on said fitting-socket; at this position, the funnel-shaped mouth of the passageway of the multifunctional cap, just touching and closing the tip of the nozzle of the aerosol valve without applying pressure, thus connecting said passageway with the nozzle of the aerosol valve for the foam to flow through;
Once the notched circular surface is depressed, all the multifunctional cap goes down until the second level holes on the surface of the fitting-socket of the multifunctional cap are inter-locked with the catches on the inner surface of the socket of the pressurized chamber, also causing the two parts to mount tightly, thus preventing the necessity of applying continuous force; at the same time, the funnel-shaped mouth of the passageway of the multifunctional cap presses the nozzle of the aerosol valve downwards causing it to open and remain at that position, discharge the pressurized content throughout the nozzle of the aerosol valve first and the passageway of the multifunctional cap afterwards, pouring off the mouth of the discharge nozzle of the multifunctional cap at the end till all the pressurized content within the chamber is expelled;
And a box to package the above-mentioned three pieces; slightly bigger than a standard matchbox; like a matchbox having a drawer or an open top; made of cardboard, pasteboard, plastic or a similar substance; inside of which the above-mentioned three pieces of the shaving set are placed firmly on a fixing-bed manufactured of sponge, foam or a similar light material such that they do not make any noise when shaken; said fixing-bed having grooves at both sides of the mid portion of each piece to enable easy pick-up with the thumb and the forefinger; wrapped with cellophane or similar air-preventing material to sustain hygienic requirements created thereof.

3. A single-use disposable shaving set as set forth in claim 2 wherein said shaving head further including a razor blade cover in the form of a rectangular tape or film made of nylon or a similar soft substance, thin but tear-resistant, to be smoothly stuck on the edges of the shaving head, covering the blades, either by a kind of adhesive or by any means of welding such that it may not be stuck on again once peeled off; said blade cover to be facilitated primarily for assuring hygiene, that is, the peeler is, without any doubt, the first to peel out the tape and make use of the shaving head.

4. A single-use disposable shaving set as set forth in claim 3 wherein said razor blade cover to be facilitated as a blade protector for the shaving head.

5. A single-use disposable shaving set as set forth in claim 3 wherein said razor blade cover to be facilitated for to prevent accidental injuries while mounting.

6. A single-use disposable shaving set as set forth in claim 1 wherein shaving foam meaning all kinds of lather-forming substances which transform into lather or foam when discharged from a container through an aerosol valve under high pressure created by the propellant contained therein.

7. A single-use disposable shaving set as set forth in claim 2 wherein shaving foam meaning all kinds of lather-forming substances which transform into lather or foam when discharged from a container through an aerosol valve under high pressure created by the propellant contained therein.
